(19) United States
(12) Patent Application Publication
(10) Pub. No.: US 2018/0023404 A1
(43) Pub. Date: Jan. 25, 2018

(54) RING SEGMENT SYSTEM FOR GAS TURBINE ENGINES

(71) Applicant: Siemens Aktiengesellschaft, München (DE)

(72) Inventors: Marco Claudio Pio Brunelli, Orlando, FL (US); Sameer Ahmed Khan, Orlando, FL (US); Matthew J. LaGrow, Winter Garden, FL (US); William W. Pankey, Palm Beach Gardens, FL (US); Walter H. Marussich, Palm Beach Gardens, FL (US); Beatriz Suarez-Crosse, West Palm Beach, FL (US); Kenneth K. Landis, Tequesta, FL (US)

(21) Appl. No.: 15/546,675

(22) PCT Filed: Feb. 16, 2015
(86) PCT No.: PCT/US2015/015991

§ 371 Date: Jul. 27, 2017

(51) Int. Cl. F01D 9/04

(52) U.S. Cl. CPC F01D 9/04; F05D 2240/11; F05D 2260/201; F05D 2260/205

(57) ABSTRACT

A ring segment system (100) for a gas turbine engine (10) is disclosed. The ring segment system (100) may be formed from ring segments (50) that circumferentially surround a rotor assembly (40). The ring segments (50) may each include a carrier portion (34) that is coupled to a vane carrier (28), and a heat shielding portion (38) that is detachably coupled to the carrier portion (34). The detachable coupling may allow the heat shielding portion (38) to be uncoupled from the carrier portion (34) and removed from the gas turbine engine (10) axially. The ring segments (50) may further include cooling fluid supply channels (72) that allow cooling fluid to flow from a radially outward facing backside (42) of the ring segments (50) to a radially inward facing front side (46). Additionally, the ring segments (50) may also include ingestion prevention channels (76) that allow cooling fluid to create a barrier over the gap (80) between the ring segments (50) and the adjacent vane (18).

### FIELD OF THE INVENTION

This invention relates generally to gas turbine engines, and more particularly to a ring segment system for gas turbine engines.

### BACKGROUND

Turbine engines commonly include ring segments assembled together circumferentially around the turbine blades. The ring segments may define the flow path of hot compressed gas radially outward of the turbine blades. Typical ring segments, however, may be deficient, as they may be susceptible to failure due to the high temperature of the hot compressed gas or due to static pressure loads and dynamic excitation pulses in the turbine engines, or both.

### SUMMARY OF THE INVENTION

A ring segment system for a gas turbine engine is disclosed. The ring segment system may be formed from ring segments that circumferentially surround a rotor assembly of the gas turbine engine. The ring segments may each include a carrier portion that is coupled to a vane carrier of the gas turbine engine, and a heat shielding portion that is detachably coupled to the carrier portion. The detachable coupling may allow the heat shielding portion to be uncoupled from the carrier portion and removed from the gas turbine engine axially. As such, the gas turbine engine, the vane carrier, and/or the outer casing may not need to be disassembled in order to remove and/or replace the heat shielding portion. The ring segments may further include cooling fluid supply channels that allow cooling fluid to flow from a radially outward facing backside of the ring segments to a radially inward facing front side. Therefore, additional cooling may be provided to the ring segments. Additionally, the ring segments may also include ingestion prevention channels that allow cooling fluid to create a barrier over the gap and between the ring segments and the adjacent vane. This curtain of air may at least partially prevent hot gas ingestion through the gap.

In at least one embodiment, a turbine engine may include a rotor assembly having at least one circumferentially aligned row of turbine blades extending radially outward therefrom. The turbine engine may further include a vane carrier positioned circumferentially around at least a portion of the rotor assembly. The vane carrier may have at least one circumferentially aligned row of vanes extending radially inward therefrom. The turbine engine may also include one or more ring segments positioned radially outward from the circumferentially aligned row of turbine blades and further positioned radially inward from at least a portion of the vane carrier. Each of the one or more ring segments may include a carrier portion coupled to the vane carrier and a heat shielding portion positioned radially inward from the carrier portion. The heat shielding portion may be detachably coupled to the carrier portion. The detachable coupling is configured to allow the heat shielding portion to be uncoupled from the carrier portion and removed from the turbine engine axially.

The heat shielding portion may further include a radially outward facing backside that has a plurality of rails forming at least a portion of the detachable coupling. A first of the plurality of rails may include at least one coupling protrusion oriented to face axially upstream. A second of the plurality of rails may include at least one coupling protrusion oriented to face axially downstream. A third of the plurality of rails may be positioned between the first of the plurality of rails and the second of the plurality of rails. The third of the plurality of rails may include at least one coupling protrusion oriented to face axially downstream. A fourth of the plurality of rails may be positioned between the third of the plurality of rails and the second of the plurality of rails. The fourth of the plurality of rails may include at least one coupling protrusion oriented to face axially downstream.

The coupling protrusion of the first of the plurality of rails may include a plurality of coupling protrusions oriented to face axially upstream. Each of the coupling protrusions of the first of the plurality of rails may be circumferentially spaced from another of the coupling protrusions of the first of the plurality of rails so as to form a first interrupted rail. The at least one coupling protrusion of the second of the plurality of rails may include a single coupling protrusion oriented axially downstream. The single coupling protrusion of the second of the plurality of rails may extend along an entire length of the second of the plurality of rails so as to form a first uninterrupted rail. The at least one coupling protrusion of the third of the plurality of rails may include a plurality of coupling protrusions oriented to face axially downstream. Each of the coupling protrusions of the third of the plurality of rails may be circumferentially spaced from another of the coupling protrusions of the third of the plurality of rails so as to form a second interrupted rail. The at least one coupling protrusion of the fourth of the plurality of rails may include a single coupling protrusion oriented to face axially downstream. The single coupling protrusion of the fourth of the plurality of rails may extend along an entire length of the fourth of the plurality of rails so as to form a second uninterrupted rail.

The radially outward facing backside of the heat shielding portion may further include at least three impingement cavities formed by the plurality of rails. Each of the impingement cavities may have a pressure inside of the impingement cavity, and the pressure inside of the third impingement cavity may be different from the pressures inside of the first and second impingement cavities. Furthermore, the pressure inside of the second impingement cavity may be different from the pressure inside of the first impingement cavity.

The heat shielding portion may further include one or more channels formed underneath the second of the plurality of rails. Each of the channels may include an inlet formed in the radially outward facing backside and an outlet formed in a downstream facing edge of the heat shielding portion. The inlet may be in fluid communication with the outlet. Furthermore, the channels may be configured to prevent at least a portion of hot gas ingestion in a gap between the ring segment and the circumferentially aligned row of vanes.

The heat shielding portion may further include a radially inward facing front side, and one or more channels formed in the heat shielding portion. Each of the channels may have an inlet formed in the radially outward facing backside and an outlet formed in the radially inward facing front side. The inlet may be in fluid communication with the outlet. Furthermore, the channels may be a plurality of channels arranged in each of a plurality of axially spaced rows. The first impingement cavity may include a first set of one or more of the axially spaced rows, the second impingement cavity may include a second set of one or more of the axially spaced rows, and the third impingement cavity may include a third set of one or more of the axially spaced rows.

The carrier portion may include at least two isolation rings configured to couple the carrier portion to the vane carrier. Furthermore, the at least two isolation rings may be configured to allow the carrier portion to be uncoupled from the vane carrier and removed from the turbine engine circumferentially. Also, the one or more ring segments may include a plurality of ring segments coupled to each other and positioned to circumferentially surround the rotor assembly.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a cross-sectional view of a turbine engine with an example of a ring segment system.

FIGS. 2-3 are cross-sectional views of examples of the ring segment system.

FIGS. 4-7 are perspective views of examples of the ring segment system.

### DETAILED DESCRIPTION OF THE INVENTION

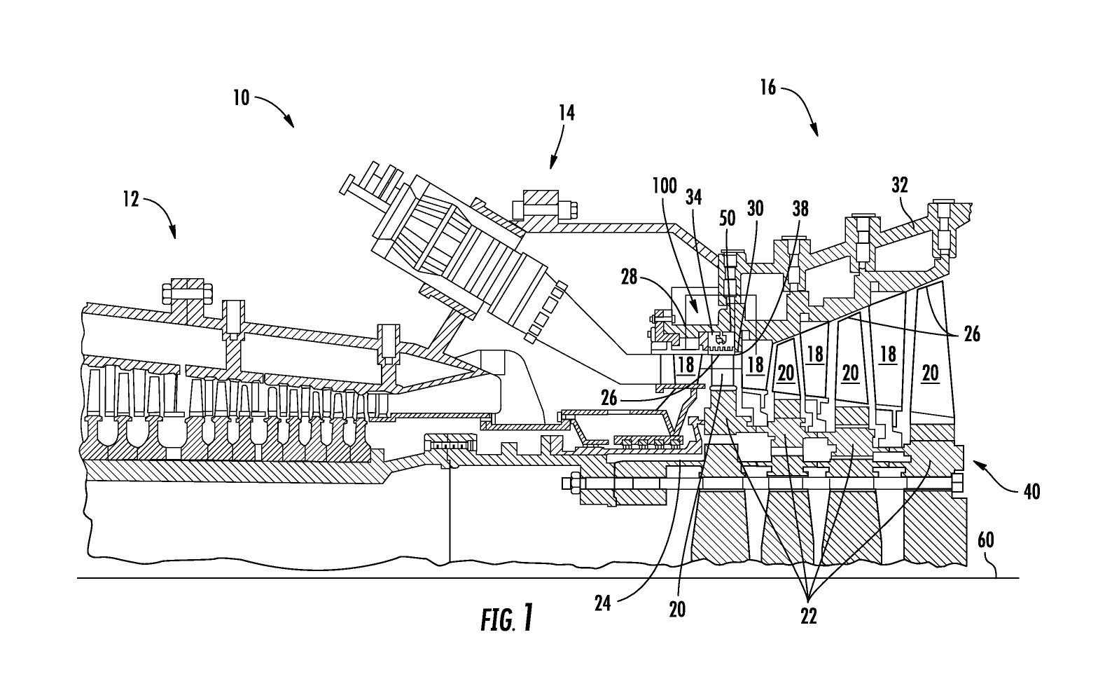

As shown in FIGS. 1-12, a ring segment system 100 for a gas turbine engine 10 is disclosed. The ring segment system 100 may be formed from ring segments 50 that circumferentially surround a rotor assembly 40 of the gas turbine engine 10. The ring segments 50 may each include a carrier portion 34 that is coupled to a vane carrier 28 of the gas turbine engine 10, and a heat shielding portion 38 that is detachably coupled to the carrier portion 34. The detachable coupling may allow the heat shielding portion 38 to be uncoupled from the carrier portion 34 and removed from the gas turbine engine 10 axially. As such, the gas turbine engine 10, the vane carrier 28, and/or the outer casing 32 may not need to be disassembled in order to remove and/or replace the heat shielding portion 38. The ring segments 50 may further include cooling fluid supply channels 72 that allow cooling fluid to flow from a radially outward facing backside 42 of the ring segments 50 to a radially inward facing front side 46. Therefore, additional cooling may be provided to the ring segments 50. Additionally, the ring segments 50 may also include ingestion prevention channels 76 that allow cooling fluid to create a barrier over the gap 80 between the ring segments 50 and the adjacent vane 18. This curtain of air may at least partially prevent hot gas ingestion in the gap 80. Aspects of the invention will be explained in connection with an example ring segment system 100. Notably, one or more of the disclosed features may be used in other ring segment system 100 configurations. For example, cooling fluid supply channels 72 and/or ingestion prevention channels 76 may be used in other ring segment system 100 configurations.

As shown in FIG. 1, the turbine engine 10 may include a compressor 12, a combustor 14 (positioned downstream of the compressor 12 and upstream of the turbine section 16), and the turbine section 16 (positioned downstream of the compressor 12 and the combustor 14) with alternating rows of stationary airfoils 18, commonly referred to as vanes 18, and rotating airfoils 20, commonly referred to as blades 20. Each row of blades 20 may be formed by a plurality of airfoils 20 attached to a disc 22 provided on a rotor 24 to form a rotor assembly 40. The blades 20 may extend radially outward from the discs 22 and terminate in a region known as the blade tip 26. Each row of vanes 18 may be formed by attaching one or more vanes 18 to a turbine engine support structure, such as, but not limited to, a vane carrier 28, which may also be referred to as a turbine shroud support (hooks), ring segment support (hooks) and blade outer air seal support (hooks). The vanes 18 may extend radially inward from an inner peripheral surface 30 of the vane carrier 28 and terminate proximate to the rotor 24. The vane carrier 28 may be attached to an outer casing 32, which may enclose the turbine section 16 of the engine 10. The turbine engine 10 may further include a ring segment system 100 connected to the vane carrier 28 between the rows of vanes 18. The ring segment system 100 may be a stationary component positioned radially outward from the rotating blades 20, and that acts as a hot gas path guide. The ring segment system 100 may be formed by a plurality of circumferentially aligned ring segments 50. The ring segments 50 may be coupled to each other (via mate faces and shiplaps) so as to circumferentially surround the rotor assembly 40.

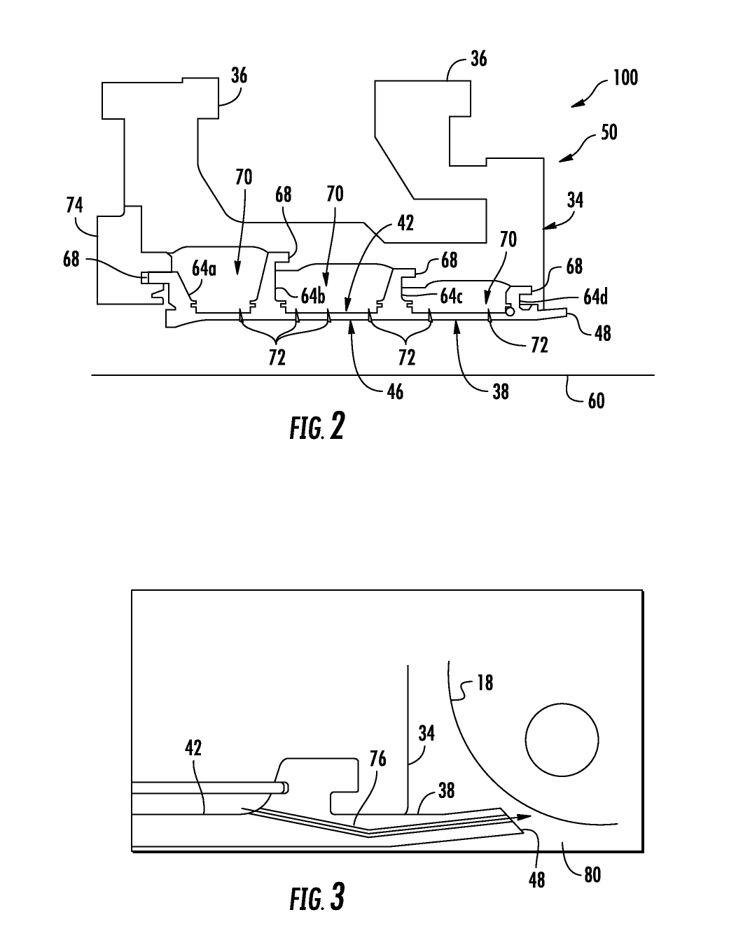

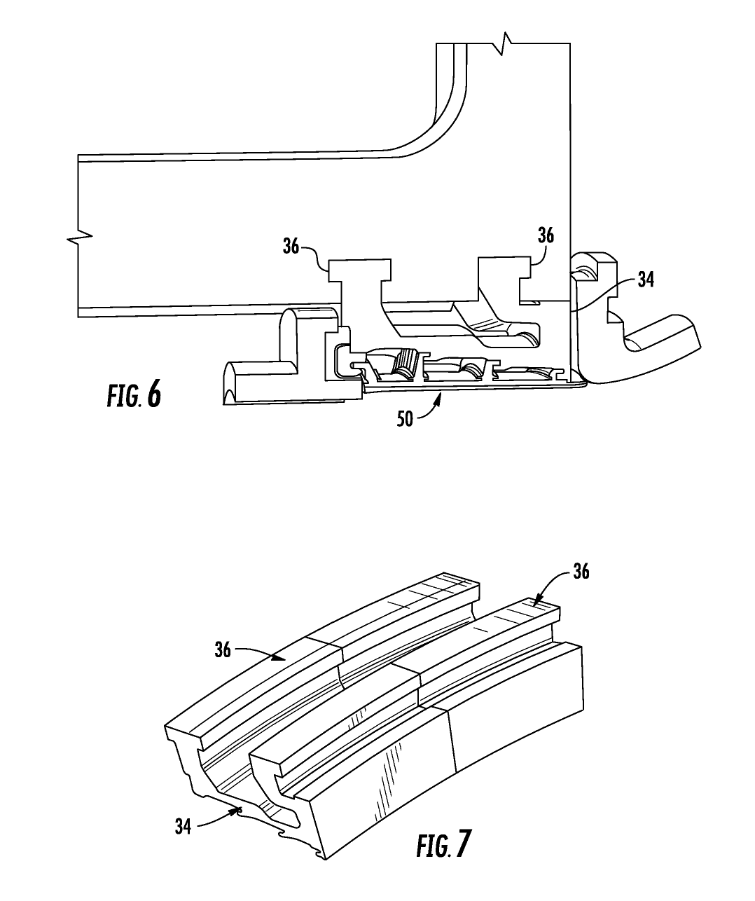

As shown in FIG. 2, the ring segment 50 includes at least two parts: a carrier portion 34 and a heat shielding portion 38. The carrier portion 34 is attached to the vane carrier 28. For example, the carrier portion 34 may include two or more attachments 36 (otherwise known as isolation rings 36) that connect the carrier portion 34 to the vane carrier 28. Further views of isolation rings 36 and carrier portion 34 are illustrated in FIGS. 6-7. To install and/or remove the carrier portion 34 from the vane carrier 28 and turbine engine 10, the carrier portion 34 may be installed and/or removed in a circumferential direction (as opposed to the axial direction 60 discussed below with regard to the heat shielding portion 38). In particular embodiments, the carrier portion 34 may act as the support structure of the ring segment 50. As such, the carrier portion 34 may be configured to handle static pressure loads and dynamic excitation pulses in the turbine engine 10.

Additionally, the ring segment 50 further includes a heat shielding portion 38. In particular embodiments, the heat shielding portion 38 may be configured to protect the ring segment 50, the vane carrier 28, and the outer casing 32 from the high temperatures of the hot compressed gas. As such, the ring segment 50 includes a carrier portion 34 that is configured to provide structural support for the ring segment 50, and a separate heat shielding portion 38 that provides high temperature protection for the ring segment 50. Conventionally, these two functions may have been performed by a single part, or a single part that includes a heat shielding coating. However, by separating these two functions into two separate parts (i.e., a carrier portion 34 and a heat shielding portion 38), the ring segment 50 may more efficiently provide for both functions as each part may be specifically configured to handle its respective function.

The heat shielding portion 38 may be detachably coupled to the carrier portion 34 in a manner that allows the heat shielding portion 38 to be detached from the carrier portion 34 and removed from the turbine engine 10 axially (such as in the axial direction 60). In particular embodiments, this may differ from conventional ring segments which could only be installed and/or removed from the turbine engine 10 in a circumferential direction, and which may require the vane carrier 28, the outer casing 32, and/or the turbine engine 10 to be disassembled. Contrary to these conventional ring segments, the heat shielding portion 38 may be installed and/or removed without disassembling the vane carrier 28, the outer casing 32, and/or the turbine engine 10. In particular embodiments, this may allow for easier replacement of the heat shielding portion 38 when it is damaged by the high temperatures of the hot compressed gas. Also, because the heat shielding portion 38 may be detached from the carrier portion 34, the entire ring segment 50 may not need to be replaced when the heat shielding portion 38 is damaged. Instead, only the heat shielding portion 38 of the ring segment 50 may be replaced.

As is further shown in FIG. 2, the heat shielding portion 38 includes a body having a backside surface 42 positioned radially outward and a front side 46 positioned radially inward. The heat shielding portion 38 is positioned to substantially surround a row of blades 20 when installed such that the tips 26 of the rotating blades 20 are in close proximity to the heat shielding portion 38. The backside surface 42 includes a plurality of rails 64 that form a portion of the detachable coupling of the heat shielding portion 38 to the carrier portion 34. The rails 64 may have any distance between each other, and any size and/or shape. In particular embodiments, the distance between each rail 64, the size of the rail 64, and/or the shape of each rail 64 may be selected to reduce stresses and dynamic sensitivity to blade 20 passing excitation. Each of the rails 64 includes at least one coupling protrusion 68 that is oriented to face a particular direction. The coupling protrusion 68 may be any type of protrusion, and may have any size and/or shape for coupling the heat shielding portion 38 to the carrier portion 34. For example, the coupling protrusion 68 may be a horizontally angled hook that fits within a female connector on the carrier portion 34. The coupling protrusion 68 may be oriented to face any direction. For example, the at least one coupling protrusion 68 of rail 64a (which is the rail 64 positioned furthest upstream on the heat shielding portion 38) is oriented to face axially upstream (i.e., it faces upstream in the axial direction 60). As another example, the at least one coupling protrusion 68 of each of rails 64b, 64c, and 64d are oriented to face axially downstream (i.e., they face downstream in the axial direction 60). In particular embodiments, as a result of such a configuration, the heat shielding portion 38 may be installed and/or removed axially. For example, the upstream coupling portion 74 (which may assist in coupling heat shielding portion 38 to carrier portion 34) may be removed (e.g., by unscrewing one or more screws that couple upstream coupling portion 74 to both heat shielding portion 38 and carrier portion 34). Additionally, the heat shielding portion 38 may then be removed axially (e.g., by sliding the heat shielding portion 38 upstream in the axial direction 60).

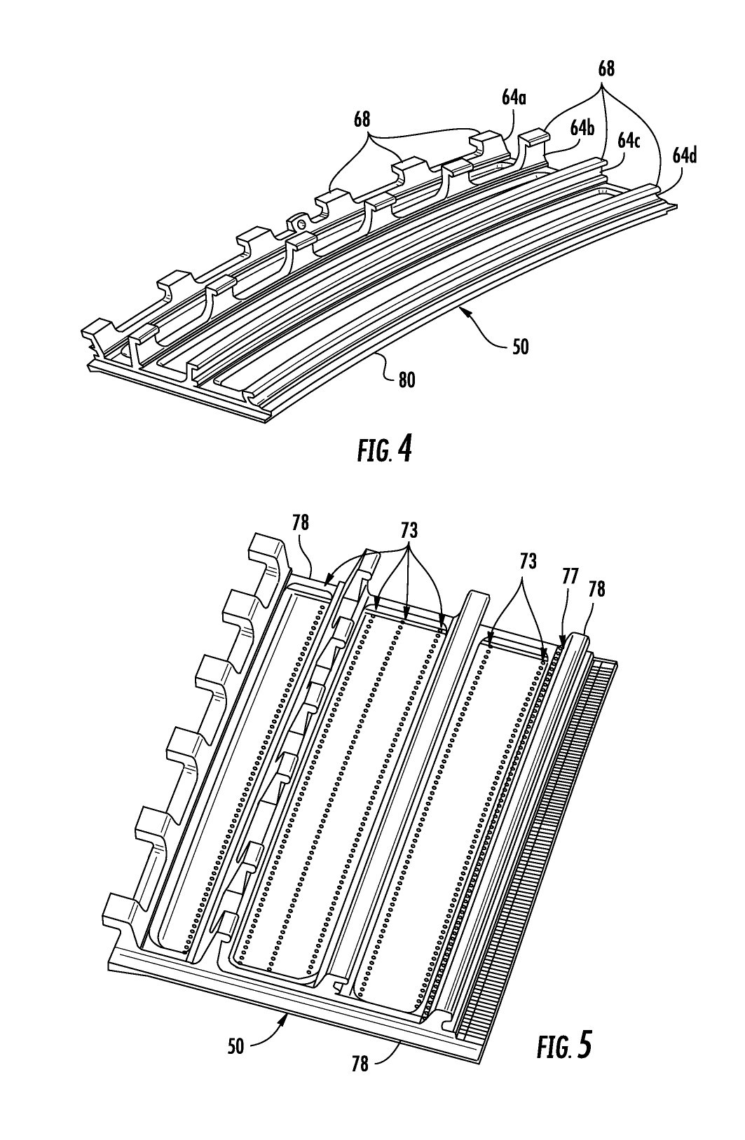

Each rail 64 may have any suitable number of coupling protrusions 68. For example, as is illustrated in FIGS. 4-5, rail 64a may have a plurality of coupling protrusion 68 (or hooks 68) oriented to face axially upstream. Each of the coupling protrusions 68 of rail 64a may be circumferentially spaced from one another, thereby forming an interrupted rail 64. The plurality of coupling protrusions 68 of rail 64a may include any number of coupling protrusions 68, and the coupling protrusions 68 may be circumferentially spaced apart from each other for any amount of distance. In particular embodiments, the number of coupling protrusions 68 and the amount of spacing between each coupling protrusion 68 may be selected in order to create a particular pressure in the impingement cavity 70 located downstream of rail 64a.

As another example, as is illustrated in FIGS. 4-5, rail 64b may have a plurality of coupling protrusions 68 oriented to face axially downstream. Each of the coupling protrusions 68 of rail 64b may be circumferentially spaced from one another, thereby forming an interrupted rail 64. The plurality of coupling protrusions 68 of rail 64b may include any number of coupling protrusions 68, and the coupling protrusions 68 may be circumferentially spaced apart from each other for any amount of distance. In particular embodiments, the number of coupling protrusions 68 and the amount of spacing between each coupling protrusion 68 may be selected in order to create a particular pressure in the impingement cavity 70 located downstream of rail 64b.

As a further example, as is also illustrated in FIGS. 4-5, rails 64c and 64d may each have a single coupling protrusion 68 oriented to face axially downstream. The single coupling protrusion 68 of each of rails 64c and 64d may extend along an entire length of each of rails 64c and 64d so as to form uninterrupted rails 64. In particular embodiments, the single coupling protrusion 68 of each of rails 64c and 64d may extend along substantially all of the entire length of each of rails 64c and 64d. For example, the single coupling protrusion 68 may not extend all the way to the end of either side (or both sides) of the rail 64.

The rails 64 may form impingement cavities 70 on the backside 42 of the heat shielding portion 38. The rails 64 may form any suitable number of impingement cavities 70, such as one impingement cavity 70, two impingement cavities 70, three impingement cavities 70, four impingement cavities 70, or any other number of impingement cavities 70. As an example, rails 64a and 64b may form a first impingement cavity 70 between each other, rails 64b and 64c may form a second impingement cavity 70 between each other, and rails 64c and 64d may form a third impingement cavity 70 between each other. Each of the impingement cavities 70 may have a different pressure, or two or more of the impingement cavities 70 may have the same pressure. In particular embodiments, the pressure in each of the impingement cavities 70 may be the result of the type of rails 64 that form the impingement cavity 70 (e.g., the rail is interrupted or uninterrupted), the distance between each rail 64 that forms the impingement cavity 70, the amount of air entering the impingement cavity 70, and/or the amount of air exiting the impingement cavity 70.

As shown in FIGS. 2 and 5, the heat shielding portion 38 further includes one or more cooling fluid supply channels 72 that allow cooling fluid to flow from the backside 42 of the heat shielding portion 38 to the front side 46 of the heat shielding portion 38. In particular embodiments, this may allow cooling fluid to exit one or more of the impingement cavities 70 and cool the front side 46 of the heat shielding portion 38, thereby providing additional cooling to the ring segment 50. Heat shielding portion 38 may include any number of cooling fluid supply channels 72. For example, as shown in FIG. 5, the heat shielding portion 38 may include one or more axially spaced rows 73 of cooling fluid supply channels 72. Each axially spaced row 73 may include any number of cooling fluid supply channels 72, and the heat shielding portion 38 may include any number of axially spaced row 73. For example, the impingement cavity 70 formed by rails 64a and 64b may include a single axially spaced row 73 of cooling fluid supply channels 72, the impingement cavity 70 formed by rails 64b and 64c may include three axially spaced rows 73 of cooling fluid supply channels 72, and the impingement cavity 70 formed by rails 64c and 64d may include two axially spaced rows 73 of cooling fluid supply channels 72. Furthermore, the axially spaced rows 73 may be spaced apart from each other by any amount of distance, and the cooling fluid supply channels 72 in each axially spaced row 73 may also be spaced apart from each other by any amount of distance.

A cooling fluid supply channel 72 may include an inlet formed in the backside 42 of the heat shielding portion 38 and an outlet formed in the front side 46 of the heat shielding portion 38. As such, the cooling fluid may pass from an impingement cavity 70 to radially inward of the front side 46, thereby cooling the front side 46 of the heat shielding portion 38. The cooling fluid supply channel 72 may have any suitable size and/or shape. Also, each cooling fluid supply channel 72 may have the same size and/or shape, or one or more of the cooling fluid supply channels 72 may have a different size and/or shape. The cooling fluid supply channel 72 may be formed at any angle through the heat shielding portion 38. For example, the cooling fluid supply channel 72 may be formed orthogonal to the backside 42 and front side 46 of the heat shielding portion 38, angled downstream axially, angled toward or away from connection edges 78 (shown in FIG. 5), or any combination of the preceding. Additionally, all of the cooling fluid supply channels 72 may be formed at the same angle, or one or more of the cooling fluid supply channels 72 may be formed at different angles.

The heat shielding portion 34 may further include one or more additional structures to provide increased cooling of the ring segment 50. For example, in addition to the cooling fluid supply channels 72, the heat shielding portion 34 may further include pin fins (or any other heat transfer structure) to provide additional cooling.

As shown in FIGS. 3 and 5, the heat shielding portion 38 further includes one or more ingestion prevention channels 76 that allow cooling fluid to create a barrier over the gap 80 and between the ring segments 50 and an adjacent vane 18. Heat shielding portion 38 may include any number of ingestion prevention channels 76. For example, as is illustrated in FIG. 5, the heat shielding portion 38 may include a row 77 of ingestion prevention channels 76. An ingestion prevention channel 76 may be formed underneath the furthest downstream rail 64 (e.g., rail 64d) of the heat shielding portion 38. The ingestion channel 76 may include an inlet formed in the backside 42 of the heat shielding portion 38 and an outlet formed in the downstream facing edge 48 of the heat shielding portion 38. As such, the cooling fluid may pass from an impingement cavity 70 to downstream of the downstream facing edge 48 of the heat shielding portion 38. The ingestion prevention channel 76 may have any size, shape, and/or distance between an adjacent ingestion prevention channel 76. Also, each ingestion prevention channel 76 may have the same size, shape, and/or distance between an adjacent ingestion prevention channel 76, or one or more of the ingestion prevention channels 76 may have a different size, shape, and/or distance between an adjacent ingestion prevention channel 76.

Furthermore, the ingestion prevention channel 76 may be formed at any suitable angle through the heat shielding portion 38. For example, as is illustrated in FIG. 3, the ingestion prevention channel 76 may be formed at a generally axial angle. This may allow the cooling fluid to exit the ingestion prevention channel 76 at a high speed (such as a high mach number speed) to form a curtain of air that may act as a barrier over the gap 80 and between the ring segment 50 and the adjacent vane 18. In particular embodiments, this curtain of air created by the ingestion prevention channels 76 may prevent at least a portion of hot gas ingestion in the gap 80. Furthermore, all of the ingestion prevention channels 76 may be formed at the same angle, or one or more of the ingestion prevention channels 76 may be formed at different angles.

The foregoing is provided for purposes of illustrating, explaining, and describing embodiments of this invention. Modifications and adaptations to these embodiments will be apparent to those skilled in the art and may be made without departing from the scope or spirit of this invention.

What is claimed is:

1. A turbine engine (10), characterized in that:
a rotor assembly (40) having at least one circumferentially aligned row of turbine blades (20) extending radially outward therefrom;
a vane carrier (28) positioned circumferentially around at least a portion of the rotor assembly (40), the vane carrier (28) having at least one circumferentially aligned row of vanes (18) extending radially inward therefrom; and
one or more ring segments (50) positioned radially outward from the circumferentially aligned row of turbine blades (20) and further positioned radially inward from at least a portion of the vane carrier (28), each of the one or more ring segments (50) characterized in that:
a carrier portion (34) coupled to the vane carrier (28); and
a heat shielding portion (38) positioned radially inward from the carrier portion (34), the heat shielding portion (38) being detachably coupled to the carrier portion (34), characterized in that the detachable coupling is configured to allow the heat shielding portion (38) to be uncoupled from the carrier portion (34) and removed from the turbine engine (10) axially.

2. The turbine engine (10) of claim 1, characterized in that:
the heat shielding portion (38) comprises a radially outward facing backside (42) that includes a plurality of rails (64) forming at least a portion of the detachable coupling;
a first of the plurality of rails (64) includes at least one coupling protrusion (68) oriented to face axially upstream; and
a second of the plurality of rails (64) includes at least one coupling protrusion (68) oriented to face axially downstream.

3. The turbine engine (10) of claim 2, characterized in that:
a third of the plurality of rails (64) includes at least one coupling protrusion (68) oriented to face axially downstream, the third of the plurality of rails (64) being positioned between the first of the plurality of rails (64) and the second of the plurality of rails (64); and
a fourth of the plurality of rails (64) includes at least one coupling protrusion (68) oriented to face axially downstream, the fourth of the plurality of rails (64) being positioned between the third of the plurality of rails (64) and the second of the plurality of rails (64).

4. The turbine engine (10) of claim 3, characterized in that:
the radially outward facing backside (42) further includes at least three impingement cavities (70) formed by the plurality of rails (64);
each of the impingement cavities (70) have a pressure inside of the impingement cavity (70); and
the pressure inside of the third impingement cavity (70) is different from the pressures inside of the first and second impingement cavities (70).

5. The turbine engine (10) of claim 4, characterized in that the pressure inside of the second impingement cavity (70) is different from the pressure inside of the first impingement cavity (70).

6. The turbine engine (10) of claim 3, characterized in that:
the at least one coupling protrusion (68) of the first of the plurality of rails (64) comprises a plurality of coupling protrusions (68) oriented to face axially upstream, each of the plurality of coupling protrusions (68) of the first of the plurality of rails (64) being circumferentially spaced from another of the plurality of coupling protrusions (68) of the first of the plurality of rails (64) so as to form a first interrupted rail (64); and
the at least one coupling protrusion (68) of the second of the plurality of rails (64) comprises a single coupling protrusion (68) oriented to face axially downstream, the single coupling protrusion (68) of the second of the plurality of rails (64) extending along an entire length of the second of the plurality of rails (64) so as to form a first uninterrupted rail (64).

7. The turbine engine (10) of claim 6, characterized in that:
the at least one coupling protrusion (68) of the third of the plurality of rails (64) comprises a plurality of coupling protrusions (68) oriented to face axially downstream, each of the plurality of coupling protrusions (68) of the third of the plurality of rails (64) being circumferentially spaced from another of the plurality of coupling protrusions (68) of the third of the plurality of rails (64) so as to form a second interrupted rail (64); and
the at least one coupling protrusion (68) of the fourth of the plurality of rails (64) comprises a single coupling protrusion (68) oriented to face axially downstream, the single coupling protrusion (68) of the fourth of the plurality of rails (64) extending along an entire length of the fourth of the plurality of rails (64) so as to form a second uninterrupted rail (64).

8. The turbine engine (10) of claim 1, characterized in that:
the carrier portion (34) includes at least two isolation rings (36) configured to couple the carrier portion (34) to the vane carrier (28); and
the at least two isolation rings (36) are configured to allow the carrier portion (34) to be uncoupled from the vane carrier (28) and removed from the turbine engine (10) circumferentially.

9. The turbine engine (10) of claim 1, characterized in that the one or more ring segments (50) comprise a plurality of ring segments (50) coupled to each other and positioned to circumferentially surround the rotor assembly (40).

10. The turbine engine (10) of claim 2, characterized in that the heat shielding portion (38) includes one or more channels (76) formed underneath the second of the plurality of rails (64), each of the one more channels (76) including an inlet formed in the radially outward facing backside (42) and an outlet formed in a downstream facing edge (48) of the heat shielding portion (38), characterized in that the inlet of the each of the one more channels (76) is in fluid communication with the outlet of the each of the one more channels (76).

11. The turbine engine (10) of claim 10, characterized in that the one or more channels (76) are configured to prevent at least a portion of hot gas ingestion in a gap (80) between the one or more ring segments (50) and the at least one circumferentially aligned row of vanes (18).

12. The turbine engine (10) of claim 1, characterized in that the heat shielding portion (38) includes a radially outward facing backside (42) and a radially inward facing front side (46), the heat shielding portion (38) further including one or more channels (72) formed in the heat shielding portion (38), each of the one or more channels (72) having an inlet formed in the radially outward facing backside (42) and an outlet formed in the radially inward facing front side (46), characterized in that the inlet of the each of the one more channels (72) is in fluid communication with the outlet of the each of the one more channels (72).

13. The turbine engine (10) of claim 12, characterized in that the one or more channels (72) comprise a plurality of channels (72) arranged in each of a plurality of axially spaced rows (73).

14. The turbine engine (10) of claim 3, characterized in that:
the radially outward facing backside (42) further includes at least three impingement cavities (70) formed by the plurality of rails (64); and
the heat shielding portion (38) further includes a radially inward facing front side (46) and one or more channels (72) formed in the heat shielding portion (38), each of the one or more channels (72) having an inlet formed in the radially outward facing backside (42) and an outlet formed in the radially inward facing front side (46), characterized in that the inlet of the each of the one more channels (72) is in fluid communication with the outlet of the each of the one more channels (72).

15. The turbine engine (10) of claim 14, characterized in that:
the one or more channels (72) comprise a plurality of channels (72) arranged in each of a plurality of axially spaced rows (73);
the first impingement cavity (70) includes a first set of one or more of the plurality of axially spaced rows (73);
the second impingement cavity (70) includes a second set of one or more of the plurality of axially spaced rows (73); and
the third impingement cavity (70) includes a third set of one or more of the plurality of axially spaced rows (73).
